(19) United States
(12) Patent Application Publication
(10) Pub. No.: US 2025/0067998 A1
(43) Pub. Date: Feb. 27, 2025

(54) ELECTRONIC DEVICE

(71) Applicant: Apple Inc., Cupertino, CA (US)

(72) Inventors: Alison B. Shutzberg, San Francisco, CA (US); Paul Williams, Seattle, WA (US)

(21) Appl. No.: 18/586,531

(22) Filed: Feb. 25, 2024

Related U.S. Application Data
(60) Provisional application No. 63/578,664, filed on Aug. 24, 2023.

(51) Int. Cl. G02C 5/22; G02B 27/01; G02C 5/14

(52) U.S. Cl. CPC G02C 5/2263; G02B 27/0172; G02C 5/146; G02B 2027/0178

(57) ABSTRACT

A head-mountable electronic device can include a viewing frame, a window secured to the viewing frame, a waveguide configured to direct light displayed at the window, and a pair of securement arms extending distally from the viewing frame. Each securement arm of the pair of securement arms can include a splay hinge and a proximal portion connected to the viewing frame at the splay hinge, the proximal portion having a splay range of motion up to 20 degrees outward from a default position and relative to the viewing frame. The splay hinge can apply a force of the proximal portion against a head between 50 Nmm and 90 Nmm within the splay range of motion.

### CROSS-REFERENCE TO RELATED APPLICATION(S)

This claims priority to U.S. Provisional Patent Application No. 63/578,664, filed 24 Aug. 2023, and entitled “ELECTRONIC DEVICE,” the entire disclosure of which is hereby incorporated by reference in its entirety.

### FIELD

The described embodiments relate generally to electronic devices. More particularly, the present embodiments relate to head-mountable electronic devices.

### BACKGROUND

Recent advances in portable computing have enabled head-mountable electronic devices that provide augmented and virtual reality experiences to users. Various components of these devices, such as display screens, viewing frames, securement arms, speakers, batteries, and other components operate together to provide an immersive and comfortable experience. However, the anatomy of each user's head is unique. One user's head can be larger than another, or one head can be a different shape. Other anatomical features, including relative positions of a user's nose, forehead, and ears, can vary widely between users. The anatomical variety of heads presents a challenge for universal head-mountable electronic devices designed for comfort, reliability, and securement to the user's head.

Additionally, head-mountable electronic devices can be used in a variety of different settings and during a variety of different activities. These can range from lying down still in bed to mountain biking or hiking outdoors. Thus, even for a single user, the securement arms of a head-mountable electronic device that are comfortable and sufficient for securing the device during one activity may not be comfortable or sufficient for another activity. Furthermore, users often desire light weight, compact devices that are comfortable, portable, long lasting, and easily handled.

Accordingly. what is needed in the art are head-mountable electronic devices and systems providing users having a wide variety of anatomical features and who participate in a wide variety of activities with comfortable and reliable components.

### SUMMARY

In at least one example, a head-mountable electronic device can include a viewing frame, a window secured to the viewing frame, a waveguide configured to direct light displayed at the window, and a pair of securement arms extending distally from the viewing frame. Each securement arm of the pair of securement arms can include a splay hinge and a proximal portion connected to the viewing frame at the splay hinge. The proximal portion can have a splay range of motion up to 20 degrees outward from a default position and relative to the viewing frame. The splay hinge can be configured to apply a force of the proximal portion against a head between 50 Nmm and 90 Nmm within the splay range of motion.

In one example, each securement arm of the pair of securement arms can further include a tip hinge and a distal portion connected to the proximal portion at the tip hinge. The splay range of motion is a first splay range of motion and the distal portion includes a second splay range of motion up to 25 degrees outward beyond a default position of the distal portion relative to the proximal portion. The force can be a first force. The tip hinge can be configured to apply a second force of the distal portion against the head between 20 Nmm and 45 Nmm within the second splay range of motion. In one example, the first splay range of motion of the splay hinge is between 4 degrees and 15 degrees and the proximal portion is configured to apply the first force within the first splay range. The second splay range of motion of the distal hinge can be between 5 degrees and 20 degrees, and the distal portion can be configured to apply the second force within the second splay range. In one example, the splay hinge can include a cam and a leaf spring that engages the cam. In one example, the cam can include a projection that engages the leaf spring and the cam can be configured to translate relative to the projection. In one example, the proximal portion of the securement arm defines a first longitudinal axis and the splay hinge can include a compression spring defining a second longitudinal axis disposed perpendicular to the first longitudinal axis. In one example, the compression spring can be a first compression spring, and the splay hinge can include a second compression spring defining a third longitudinal axis. The third longitudinal axis can be disposed perpendicular to the first longitudinal axis and the first compression spring can be disposed above the second compression spring relative to a vertical orientation of the securement arm. In one example, the first force remains within 5 percent across the first splay range of 4 degrees and 15 degrees, and the second force remains within 5 percent across the second splay range 5 degrees and 20 degrees. In one example, the splay hinge can include a spiral spring. In one example, the spiral spring is a first spiral spring and the splay hinge can include a second spiral spring. In one example, the splay hinge can include a spring having an adjustable preload. In one example, the splay hinge can include a compression spring and a plunger. The proximal portion can include a proximal end of the securement arm The proximal end includes an engagement surface engaging the plunger to compress the compression spring during splay as the splay of the securement arm increases past the default position, a distance between where the engagement surface of the securement arm engages the plunger and an axis of rotation of the splay hinge decreases.

In at least one example, a wearable device can include a frame and a securement arm extending from the frame. The securement arm can include a distal portion, a proximal portion coupled to the frame, and a tip hinge rotatably connecting the proximal portion to the distal portion. The proximal portion can be disposed between the distal portion and the frame. The distal portion can be rotatable outward from a default position of the distal portion relative to the proximal portion. The tip hinge can include a spring configured to bias the distal portion toward the default position when the distal portion is rotated outward from the default position. The spring can include an adjustable preload.

In one example, the tip hinge can include a screw disposed within the securement arm, the screw can engage the spring. Rotation of the screw can adjust the preload of the spring. In one example, the securement arm can further include a removably attachable cover adjacent the spring, and removing the cover can provide user access to the screw. In one example, the securement arm includes an interchangeable block having a projection configured to engage the spring, the projection having a length and the preload of the spring can be based on the length. In one example, the spring is a compression spring and the preload of the spring is adjustable by compressing or decompressing the compression spring before splaying.

In at least one example, a wearable device can include a frame and a securement arms extending distally from the frame. Each securement arm of the pair of securement arms can include a proximal portion defining an engagement surface and a splay hinge coupling the proximal portion to the frame. The splay hinge can include a compression spring and a plunger. The splay hinge defines a splay angle range of the proximal portion relative to the frame of 20 degrees beyond a default angle. The engagement surface is configured to engage the plunger at a contact point to compress the compression spring during a rotation of the securement arm relative to the frame and as an angle of the securement arm relative to the frame increases beyond the default angle, a distance between the contact point and an axis of rotation of the splay hinge decreases.

In one example, the plunger includes a first projection, the engagement surface defines a second projection, and the first projection is configured to engage the second projection. In one example, the securement arm can further include a distal portion and a tip hinge coupling the proximal portion to the distal portion. The splay angle range can be a first splay angle range, and the default angle can be a first default angle. The tip hinge can define a second splay angle range of the distal portion relative to the proximal portion of 25 degrees beyond a second default angle, the tip hinge can include a spring biasing the distal portion toward the default angle, and a preload of the spring of the tip hinge can be adjustable.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a side view of an example of a head-mountable electronic device worn by a user;

FIG. 2 illustrates a top view of an example of a head-mountable electronic device;

FIG. 3 illustrates a top view of an example of a head-mountable electronic device worn by a user with a narrow head;

FIG. 4 illustrates a top view of an example of a head-mountable electronic device worn by a user with a wide head;

FIG. 5 illustrates a top view of an example of a head-mountable electronic device with a splay range of motion of a splay hinge;

FIG. 6 illustrates a top view of an example of a head-mountable electronic device with a splay range of motion of a tip hinge;

FIG. 7A illustrates a default position of a hinge system of a head-mountable electronic device that provides a quasi-constant force;

FIG. 7B illustrates the hinge system of FIG. 7A in which a cam of the hinge system rotates relative to a leaf spring;

FIG. 7C illustrates the hinge system of FIG. 7B in which the cam of the hinge system rotates and translates relative to the leaf spring;

FIG. 8A illustrates a default position of a hinge system of a head-mountable electronic device that provides a quasi-constant force;

FIG. 8B illustrates the hinge system of FIG. 8A with the hinge system splayed outward and a spring of the hinge system compressed;

FIG. 8C illustrates a perspective view of the hinge system of FIG. 8A in a default position with two springs;

FIG. 9A illustrates a default position of a hinge system of a head-mountable electronic device that provides a quasi-constant force;

FIG. 9B illustrates the hinge system of FIG. 9A with the hinge system splayed outward with a spiral spring partially unwound;

FIG. 10A illustrates a default position of a hinge system of a head-mountable electronic device that provides a quasi-constant force;

FIG. 10B illustrates the hinge system FIG. 10A with the hinge system splayed outward;

FIG. 10C illustrates the hinge system of FIG. 10A with the hinge system splayed further outward than the hinge system of 10B;

FIG. 11 illustrates a hinge system of a head-mountable electronic device that provides a quasi-constant force, the hinge system includes a compression spring with an adjustable preload;

FIG. 12 illustrates a hinge system of a head-mountable electronic device that provides a quasi-constant force, the hinge system includes a leaf spring with an adjustable preload; and

FIG. 13 illustrates a hinge system of a head-mountable electronic device that provides a quasi-constant force, the hinge system includes a leaf spring with an adjustable preload.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to electronic devices. More particularly, the present disclosure relates to wearable devices, such as head-mountable electronic devices. In at least one example, a head-mountable electronic device can include a viewing frame and a securement arm extending from the viewing frame. Examples of head-mountable electronic devices can include virtual reality or augmented reality devices that include an optical component. In the case of augmented reality devices, optical eyeglasses can be worn on the head of a user such that transparent windows, such as optical lenses and/or optical displays, are secured to the viewing frame and positioned in front of the user's eyes when the device is donned. In another example, a virtual reality device can be worn on the head of a user such that a display screen is positioned in front of the user's eyes. The viewing frame can include a housing or other structural component supporting or housing the optical component, for example lenses or screens.

Examples of the present disclosure can include a securement arm extending from the viewing frame, which can be fixed in position relative to the viewing frame or rotatably secured thereto. An optical electronic device can include two opposing securement arms that can apply pressure to, or around, a user's head to maintain the viewing frame resting on the user's nose and/or checks. In some examples, the securement arms can rest on top of the user's ears to assist in securing the head-mountable optical device to the head of the user.

The securement arm can include multiple portions and one or more electronic components used to operate the head-mountable electronic device. These components can include any components used by the head-mountable electronic device to produce a virtual or augmented reality experience. For example, electronic components of the securement arm can include one or more projectors, waveguides, speakers, processors, batteries, circuitry components including wires and circuit boards, or any other electronic components used in the head-mountable electronic device to deliver augmented or virtual reality visuals, sounds, and other outputs. Disposing various electronic components within the securement arm reduces weight and space needed for the viewing frame and lenses and/or display screens of the device. This redistributed weight can relieve pressure of sensitive features like the user's nose and checks to create a more comfortable experience. This weight distribution can also be used to balance weight from the front of the device (at the viewing frame) to the back of device (at the distal ends of the securement arms), resulting in a more secure and comfortable experience.

In examples where the securement arm includes multiple portions, a first portion can include a first electronic device and a second portion can include a second electronic device. The first portion can be connected to a second portion at a joint, and the second portion can include a second electronic device. In at least one example, the first electronic device and the second electronic device can be electrically connected with an electrical connector extending through the joint. The second portion can rotate relative to the first portion to adjust the angle of the second portion relative to the first portion. The electrical connector can extend through the joint such that rotation of the second portion at the joint does not affect the electrically connectivity of the first electrical component with the second electrical component via the electrical connector.

Head-mountable electronic devices, such as head-mountable optical devices delivering virtual and augmented reality experiences, can be used in a variety of different settings and during a variety of activities. For example, a user may lie down on a sofa or a bed while watching a movie or playing a game with a head-mountable virtual reality device. The same device, or some other augmented reality device, such as electronic glasses, can be used while exercising indoors on an exercise machine. Similarly, devices like augmented reality glasses can be used while being active outdoors, either while hiking, biking, or swimming. The devices of the present disclosure include components such as securement arms, which can be adapted to effectively secure head-mountable electronic devices to the user during any of the various activities in which the user participates.

In addition, the head measurement and anatomical features of each user can vary such that a securement arm of the same length, shape, and curvature, is not be appropriate for every user. For example, some heads are more round than others. Some heads are larger or smaller and the position of a user's nose relative to their eyes can vary. The position of a user's ears relative to their nose or forehead can vary from one user to another such that a set of securement arms that effectively secure a head-mountable electronic device to one user may not effectively secure the same device to another user.

In addition, manufacturing individualized arms for each unique customer can be burdensome and often economically infeasible. The head-mountable electronic devices of the present disclosure include securement arms and components that can be altered and customized to each user and for each activity. The same user can adjust the securement arms of a device, for example, to pressure more tightly when using the head-mountable electronic device for exercise or other active scenarios. The same user can readjust the securement arms for a more comfortable fit while using the head-mountable electronic device for less active scenarios, including lying down, sitting, or walking. In addition, some head-mountable electronic devices can be used by multiple people, including multiple people in a household or business office, with each person having a different head geometry. Securement arms for devices described herein can be customized for the same device to be comfortable and effectively used by each of the multiple individuals using the device.

The securements arms for the head-mountable electronic device can provide sufficient force (such as a torque) to the head of the user during splay of the securement arms. The force of the securement arms can provide a sufficient force to secure the head-mounted electronic device to the head of the user, but not so much force that it is uncomfortable for the user to wear. The design of the present head-mountable electronic device enables the securement arms to provide a quasi-constant force to the head of the user and maintain the quasi-constant force to a variety of different head sizes and shapes for a predetermined splay range of motion that the securement arms exhibit. The splay range of motion can also be referred to as the splay angle range.

The term “splay” should be interpreted as describing a range of motion of a component of the head-mountable electronic device. The securement arm can splay outward and away from the viewing frame of the head-mountable electronic device at a default position of the securement arm in a use position. The distal portion of the securement arm can splay outward and away from a default position of the distal portion relative to the proximal portion. The default position can include a position of the arm relative to the viewing frame when not acted upon by an outside force, including being acted on by a user or placed on the head of a user with the head forcing the arm outward to splay.

The term “outward” should be interpreted as away from the viewing frame, whereas “inward” should be interpreted herein as toward the viewing frame.

The term “quasi-constant force” should be interpreted as a force that changes only 5 percent over a predetermined splay range of motion or a predetermined splay angle range.

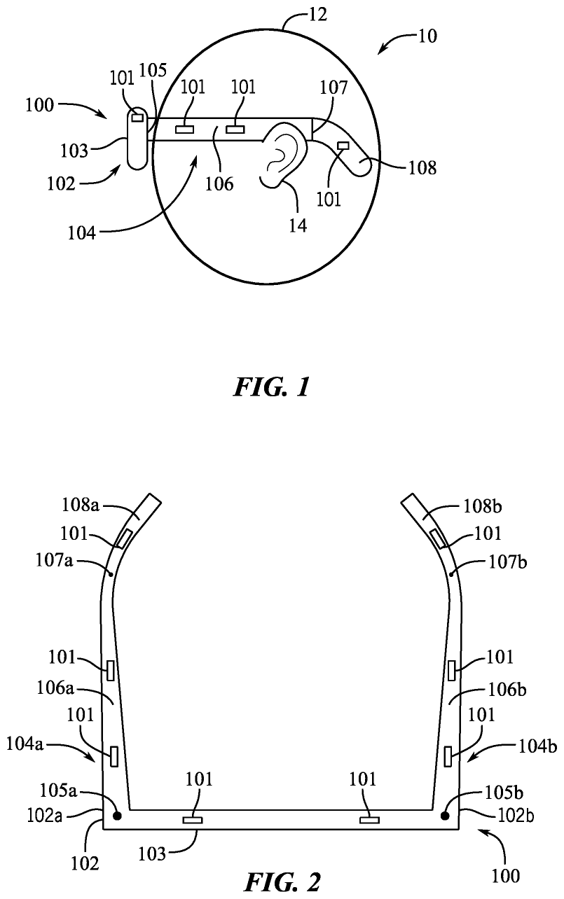

These and other embodiments are discussed below with reference to FIGS. 1-13. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a side view of an example of a head-mountable electronic device 100 worn on a head 12 of a user 10. The head-mountable electronic device 100 can be considered a wearable device. The head-mountable electronic device 100 can include a viewing frame 102 configured to secure one or more windows 103, including optically transparent windows, optical lenses, or display screens in front of the eyes of the user 10. The windows 103 can be optically transparent windows including optically transparent materials. In one example, the windows 103 are not vision correcting. In one example, the windows 103 are vision correcting lenses. The head-mountable electronic device 100 can also include one or more securement arms 104 secured to the viewing frame 102 and extending distally toward the rear of the head 12 of the user 10. In the illustrated example, only one of the securement arms 104 is visible. The one or more securement arms 104 extend over the cars 14 of the user 10. Each securement arm 104 can include a proximal portion 106 and a distal portion 108. The proximal portion 106 is coupled to the viewing frame 102 at a splay hinge 105 and the distal portion 108 is coupled to the proximal portion 106 at a tip hinge 107.

In the illustrated example, the securement arms 104 extend over the ears 14 of the user 10 and curve along with the head 12 of the user 10. The securement arms 104 can apply opposing pressure to the sides of the head 12 of the user 10, as shown, to secure the head-mountable electronic device 100 to the head 12 of the user 10. The securement arms 104 can also rest on the ears 14 of the user 10 and secure the head-mountable electronic device 100 via friction between the securement arms 104 and the head 12 of the user 10. In the illustrated example, the distal portion 108 can include a curved section that curves downward relative to the proximal portion 106 around the ears 14 of the user 10 to prevent the viewing frame 102 from being pulled forward proximally off the face/head 12 of the user 10.

In at least one example, the head-mountable electronic device 100 can include one or more electronic components 101 that add to the overall weight of the head-mountable electronic device 100. The electronic components 101 can include projectors, waveguides, batteries, speakers, processors, and so forth. FIG. 1 illustrates a plurality of electronic components 101 that are disposed in various locations on the head-mountable electronic device 100, such as the viewing frame 102, the proximal portion 106 and the distal portion 108 of the securement arm 104. In examples where the head-mounted electronic device 100 includes projectors and/or waveguides, the projectors and waveguides can be configured to direct light displayed at the windows 103. As discussed above, the weight of the electronic components can be distributed on the viewing frame 102 and the securement arms 104 to minimize the weight of the viewing frame 102 and the lenses 103 and/or display screens.

The securements arms 104 during splay provide a sufficient force to secure the head-mounted electronic device to the head 12 of the user 10, but not so much force that it is uncomfortable for the user 10 to wear. The design of the present head-mountable electronic device 100 enables the securement arms 104 to provide a quasi-constant force to the head 12 of the user 10 and maintain the quasi-constant force to a variety of different head sizes and shapes for a predetermined splay range of motion that the securement arms 104 exhibit. The splay range of motion can also be referred to as the splay angle range.

FIG. 2 illustrates a top view of the head-mountable electronic device 100. The head-mountable electronic device 100 includes a pair of securement arms 104a, 104b disposed on opposing lateral sides of the viewing frame 102. A first securement arm 104a is coupled to the viewing frame 102 at a first lateral side 102a and a second securement arm 104b is coupled to the viewing frame 102 at a second lateral side 102b opposite the first lateral side. The first securement arm 104a includes a proximal portion 106a and a distal portion 108a. In at least one example, the proximal portion 106a of the first securement arm 104a is coupled to the viewing frame 102 at a splay hinge 105a and the distal portion 108a is coupled to the proximal portion 106a at a tip hinge 107a. The second securement arm 104b can include a proximal portion 106b and a distal portion 108b. The proximal portion 106b of the second securement arm 104b can be coupled to the viewing frame 102 at a splay hinge 105b and the distal portion 108b can be coupled to the proximal portion 106b at a tip hinge 107b.

As used herein, the term “joint” or “hinge” can refer to a structure enabling one portion of either securement arm 104 to rotate or move relative to another portion, for example the proximal portions 106a, 106b relative to the viewing frame 102 about the splay hinges 105a, 105b or the distal portions 108a, 108b relative to the corresponding proximal portions 106a, 106b about the tip hinges 107a, 107b. The design and the structure of the joints, specifically the splay hinges 105a, 105b and the tip hinges 107a, 107b, can include biasing components to provide a force of the securement arms 104a and 104b against the head 12 to secure the head-mountable electronic device 100 to the head 12 of the user 10 while also providing a comfortable feel for the user 10. The force can be quasi-constant, meaning constant within plus-or-minus about 5-percent, within a range of motion of the arms 104a-b relative to the viewing frame 102.

FIG. 2 illustrates the proximal portions 106a, 106b positioned relative to the viewing frame 102. The splay hinges 105a, 105b enable the proximal portions 106a, 106b to splay or rotate outward past a default position or angle. The term “outward” as used herein with reference to the “outward” motion, movement, or repositioning of the securement arms 104a-b, can include the pivoting or rotating of the securement arms 104a-b away from the window(s) 103 secured to the viewing frame 102. The outward, splay movement or position can be opposite the inward rotation or movement of the securement arms 104a-b toward the windows 103, for example during non-use or storage of the device 100. This outward motion or position of the securement arms 104a-b away from the viewing frame 102 can also be referred to as a “splay” motion or splayed configuration of the securement arms 104a-b beyond a default position or relative angle of the securement arms 104a-b. The default position can be defined as a resting position when the securement arms 104a-b are not acted on by an external force, for example forced outward by the head of a user or by the hands of a user when donning and doffing the device. The default position can include a default angle of the securement arm 104a-b relative to the viewing frame 102. The default angle can be 90-degrees, less than 90-degrees, or greater than 90-degrees in one or more examples. In the illustrated examples herein, the default angle can be referenced as 0-degrees and the splay angles and ranges are given with reference to the 0-degree default angle of the securement arm 104a-b relative to the viewing frame 102. The default positions and angles described herein can be in reference to an angle or position of the securement arm 104a-b relative to the viewing frame 102 and/or various portions or segments of the securement arms 104a-b (e.g., distal portions and tips relative to proximal portions . . . etc.) relative to one another. In one example, the outward or splayed position or motion of either securement arm 104a-b denotes a movement or position further away from the other arm 104a-b to increase a distance or space there between. In one example, the default position of the securement arms 104a-b is perpendicular to the viewing frame 102.

For example, the top view of FIG. 2 illustrates the first and second securement arms 104a-b in a default position or angle relative to the viewing frame 102. In one example, the splay hinges 105a-b and tip hinges 107a-b allow for the “outward” “splay,” as defined above, of the securement arms 104a-b. In the top view of the example shown in FIG. 2, the first securement arm 104a rotates counterclockwise about the first splay hinge 105a to rotate “outward” or to a “splayed” or “splay” configuration/position. The second securement arm 104b rotates clockwise about the second splay hinge 105b to rotate “outward” or to a “splayed” or “splay” configuration/position. This general outward or splayed configuration of the securement arms 104a-b is used generally throughout the present disclosure and will be detailed more below. The outward/splayed configuration or motion of the securement arms 104a-b can also be referenced relative to the head 12 of the user 10 such that an outward or splayed configuration of the securement arms 104a-b denotes a movement of the securement arms 104a-b away from the head 12 or to increase a space between the securement arms 104a-b to accommodate wider heads.

The splay hinges 105a, 105b allow the head-mountable electronic device 100 to adjust to a variety of heads of different shapes and sizes. For example, the securement arms 104a, 104b can only splay a little or not at all past the default position on thin heads whereas the securement arms 104a, 104b can splay further past the default position on wider heads.

In some examples, the proximal portions 106a, 106b and distal portions 108a, 108b can be separate pieces such that the tip hinges 107a, 107b includes one or more structures rotatably connecting both separate pieces. In some examples, the securement arms 104a, 104b can include proximal portions 106a, 106b and distal portions 108a, 108b that are integrally formed as a unitary piece such that the tip hinges 107a, 107b is defined by a portion or section of the unitary piece that allows the distal portions 108a, 108b of the securement arms 104a, 104b on one side of the tip hinges 107a, 107b to rotate relative to the proximal portions 106a, 106b on the other side of the tip hinges 107a, 107b. For example, the proximal portions 106a, 106b and the distal portions 108a, 108b can be formed as a single, unitary piece and the tip hinges 107a, 107b can include a reduced cross-section or flexible portion of the unitary securement arms 104a, 104b that allows the distal portions 108a, 108b to rotate relative to the proximal portions 106a, 106b by bending the unitary securement arms 104a, 104b at the tip hinges 107a, 107b. More details regarding various examples of hinges and hinge structures are given below with reference to other figures.

Any of the features, components, and/or parts, including the arrangements and configurations thereof shown in FIGS. 1 and 2 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 1 and 2.

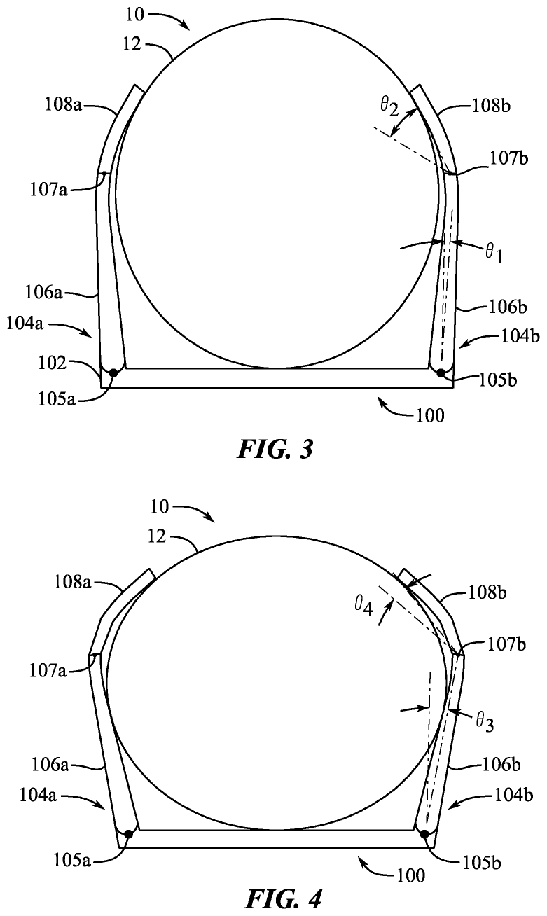

FIGS. 3 and 4 illustrate the head-mountable electronic device 100 placed on different sized and shaped heads. FIG. 3 illustrates the head-mountable electronic device 100 placed on a relatively thinner head whereas FIG. 4 illustrates the head-mountable electronic device 100 placed on a relatively wider head. As noted above, the head 12 of the user 10 can have a unique shape and size with a unique position of each car 14.

As illustrated in the examples of FIGS. 3 and 4, the securement arms 104a, 104b of the head-mountable electronic device 100 curve along with the curve of the head 12 of the user 10. The distal portion 108a, 108b of each securement arm 104a, 104b, respectively, can be curved or disposed at an angle relative to the proximal portions 106a, 106b such that at least a portion of each securement arm 104a, 104b makes contact along a length of the side of the head 12 of the user 10. In the illustrated examples of FIGS. 3 and 4, at least the distal portions 108a, 108b of the arms 104a, 104b curve with the head 12 of the user 10 to make contact with the head 12. In addition, the arms 104a, 104b can extend distally from the viewing frame 102 and curve around a portion of the back of the head 12 of the user 10, as shown, to hook around the head 12 and prevent the viewing frame 102 from being pulled forward proximally off the face/head 12 of the user 10.

In the illustrated example of FIG. 3, the proximal portions 106a, 106b of the securement arms 104a, 104b of the head-mountable electronic device 100 are splayed outward past a default or resting position/angle at a first angle θ1. The splay hinges 105a, 105b are configured to provide a force that is quasi-constant against the head 12 of the user 10 by the proximal portions 106a, 106b of the securement arms 104a, 104b between the default angle or position of the securement arms 104a-b and the first angle θ1. In at least one example, in order to provide a secure fit and prevent inadvertent drops off the head 12, as well as providing comfort to the user, the quasi-constant force of the proximal portions 106a, 106b against the head 12 can range between about 50 Nmm to 90 Nmm.

In at least one example, the distal portions 108a, 108b of the securement arms 104a, 104b, respectively, are disposed outward beyond a default position of the distal portions 108a, 108b at a second angle θ2. The tip hinges 107a, 107b can also be configured to provide a force that is quasi-constant against the head 12 of the user 10 within the range of positions defined between the default position/angle and the second angle θ2 of the distal portions 108a, 108b of the securement arms 104a, 104b. In order to provide a secure fit and prevent inadvertent drops off the head 12, as well as providing comfort to the user, The quasi-constant force of the distal portions 108a, 108b against the head 12 can range between about 15 Nmm to 50 Nmm between 0° and 25°.

The force provided by both the splay hinges 105a, 105b and the tip hinges 107a, 107b can secure the head-mountable electronic device 100 to the head 12 of the user 10. The force is a quasi-constant force sufficient to secure the head-mountable electronic device 100 to the head 12 of the user 10 yet not so much force that the force is uncomfortable for the user 10. The term quasi-constant force is defined as a force that changes up to 5 percent over the splay range of motion defined by the angles θ1 and θ2.

In the illustrated example of FIG. 4, the proximal portions 106a, 106b of the securement arms 104a, 104b of the head-mountable electronic device 100 are splayed outward past the default position at a third angle θ3, which is different than the first angle θ1. Because the head 12 in FIG. 4 is wider than the head 12 in FIG. 3, the third angle θ3 is greater than the first angle θ1. The splay hinges 105a, 105b provide a force that is quasi-constant against the head 12 of the user 10 by the proximal portions 106a, 106b of the securement arms 104a, 104b. The quasi-constant force of the proximal portions 106a, 106b against the head 12 ranges between 50 Nmm to 90 Nmm. Due to the quasi-constant nature of the splay hinges 105a, 105b, the force for the first angle θ1 is similar to the force for the third angle θ3. In other words, the force for the first angle θ1 is within 5 percent of the force for the third angle θ3.

The distal portions 108a, 108b of the securement arms 104a, 104b are disposed outward beyond a default position of the distal portions 108a, 108b relative to the proximal portion 106a, 106b at a fourth angle θ4. Because the head 12 in FIG. 4 is wider than the head 12 in FIG. 3, the second angle θ2 is greater than the fourth angle θ4 because the distal portions 108a, 108b need to come further outward than the distal portions 108a, 108b in FIG. 3. The tip hinges 107a, 107b provide a force that is quasi-constant against the head 12 of the user 10 by the distal portions 108a, 108b of the securement arms 104a, 104b. The quasi-constant force of the distal portions 108a, 108b against the head 12 can range between 15 Nmm to 50 Nmm. Due to the quasi-constant nature of the tip hinges 107a, 107b, the force for second angle θ2 is similar to the force for the fourth angle θ4. In other words, the force for the second angle θ2 is within 5 percent of the force for the fourth angle θ4. The force provided by both the splay hinges 105a, 105b and the tip hinges 107a, 107b can secure the head-mountable electronic device 100 to the head 12 of the user 10. The force is a quasi-constant force sufficient to secure the head-mountable electronic device 100 to the head 12 of the user 10 yet not so much force that the force is uncomfortable for the user 10.

Any of the features, components, and/or parts, including the arrangements and configurations thereof shown in FIGS. 3 and 4 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 3 and 4.

FIG. 5 illustrates an example of a head-mountable electronic device 100 illustrating a splay range of motion of the splay hinge 105b and the second securement arm 104b past the default position. The splay hinge 105 is biased toward the default position of the securement arm 104 relative to the viewing frame 102. While FIG. 5 only illustrates the splay range of motion of the splay hinge 105b and the second securement arm 104b, the splay hinge 105a and the first securement arm 104a can have a similar splay range of motion. The securement arm 104b can have a splay range of motion outward past the default position up to 20°. Accordingly, the proximal portion 106b applies a force to the head 12 of the user 10 between 50 Nmm and 90 Nmm as the proximal portion 106b splays between 0° and 20° past the default position with the viewing frame 102. In some examples, the proximal portion 106b applies a force to the head 12 of a user 10 between 50 Nmm and 90 Nmm as the proximal portion 106b splays between 4° and 15° past the default position with the viewing frame 102.

FIG. 5 illustrates a variety of different angles, θ5, θ6, θ7, and θ8, all of which are different. For example, θ5 can be 5°, θ6 can be 10°, θ7 can be 15°, and θ8 can be 20°. The splay range of motion of the splay hinge 105b is not limited to these specific angles, but can be any angle between 0° and 20° past the default position.

Any of the features, components, and/or parts, including the arrangements and configurations thereof shown in FIG. 5 can be included, cither alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 5.

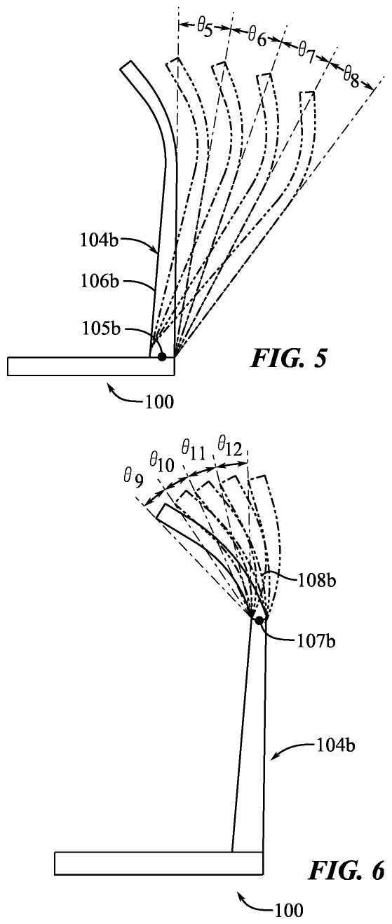

FIG. 6 illustrates the head-mountable electronic device 100 illustrating a splay range of motion of the tip hinge 107b and the distal portion 108b past the default position of the distal portion 108b of the second securement arm 104b. The tip hinge 107 is biased toward the default position of the distal portion 108b relative to the proximal portion 106b. While FIG. 6 only illustrates the splay range of motion of the tip hinge 107b and the second securement arm 104b, the tip hinge 107a and the distal portion 108b can have a similar splay range of motion. The distal portion 108b of the second securement arm 104b splays outward past the default position or angle up to 25 degrees. In some examples, the distal portion 108b of the second securement arm 104b can splay inward past the default position up to 5°. Accordingly, the distal portion 108b applies a force to the head 12 of the user 10 between 20 Nmm and 45 Nmm as the distal portion 108b splay outward between 0° and 25° degrees outward beyond the default position of the distal portion 108b relative to the proximal portion 106b. In some examples, the distal portion 108b applies a force to the head 12 of the user 10 between 20 Nmm and 45 Nmm as the distal portion 108b splay outward between 5° and 20° degrees outward beyond the default position of the distal portion 108b relative to the proximal portion 106b.

FIG. 6 illustrates a variety of different angles, θ9, θ10, θ11, and θ12, all of which are different. For example, θ9 can be 5°, θ10 can be 10°, θ1 can be 15°, and θ12 can be 25°. The splay range of motion of the splay hinge 105b is not limited to these specific angles, but can be any angle between 0° and 25° past the default position of the distal portion 108b. In some examples, the splay hinge 104b and the distal portion 108b can splay inward past the default position up to 5 degrees.

Any of the features, components, and/or parts, including the arrangements and configurations thereof shown in FIG. 6 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 6.

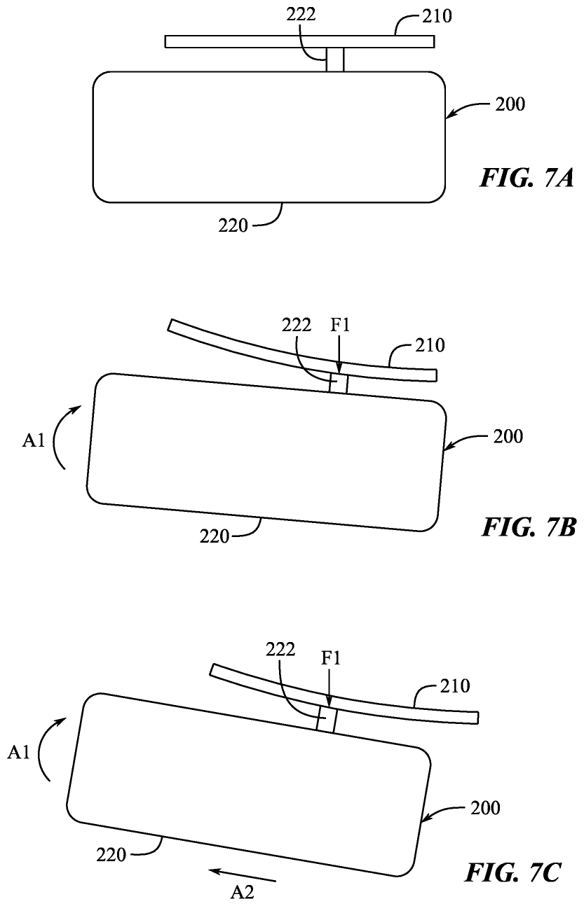

FIGS. 7A-13 illustrates various types of joint and hinge systems that can be used in either the splay hinges 105a, 105b or the tip hinges 1071, 107b in both or either of the securement arms 104a, 104b. For case of description, the following description of hinge systems, will only refer to the splay hinge 105, the tip hinge 107, the securement arm 104, the proximal portion 106 of the securement arm 104, and the distal portion 108 of the securement arm 104 rather than to both of the splay hinges 105a, 105b, the tip hinges 107a, 107b, the securement arms 104a, 104b, the proximal portions 106a, 106b, and the distal portions 108a, 108b. However, the following description and examples can be applied to any or all of the hinges disclosed herein with reference to other examples shown in other figures.

FIGS. 7A-7C illustrate an example of a hinge system 200 for either the splay hinge 105 or the tip hinge 107 that maintains a quasi-constant force of the securement arm 104 against the head 12 of the user 10. The hinge system 200 can include a leaf spring 210 and a cam 220 with a projection 222 configured to engage the leaf spring 210. While not illustrated, the leaf spring 210 can be coupled to the viewing frame 102 and the cam 220 can be anchored to the securement arm 104. In some examples, the cam 220 is integral with the securement arm 104. FIG. 7A illustrates the hinge system 200 in a default position. FIG. 7B illustrate the hinge system 200 in a partial splay in which the cam 220 rotates as illustrated by arrow A1. As discussed above, the cam 220 can rotate up to 25° depending on the placement of the hinge system 200 as either the splay hinge 105 or the tip hinge 107. As the cam 220 begins to rotate, the projection 222 engages the leaf spring 210 and a force F1 is applied to the cam 220 from the leaf spring 210. As the hinge system 200 continues to rotate, the cam 220 can also translate along arrow A2 as illustrated in FIG. 7C. In one example, the projection 222 of the cam 220 translates or slides relative to the leaf spring 210 when the securement arm 104 connected to the cam 220 is rotated/splayed such that the moment arm defined between the anchor point of the leaf spring 210 (anchored to the viewing frame) and the contact point defined between the protrusion 222 engaging the leaf spring 210 changes. As the securement arm 104 is rotated further, the moment arm increases, and thus the force F1 provided by the leaf spring 210 remains constant even as the deflection or displacement of the free end of the leaf spring 210 opposite the anchor point increases. In such an example, the force F1 can be a quasi-constant force and the force F1 in FIG. 7B and the force F1 in FIG. 7C can be similar, e.g., within about 5 percent of each other. Thus, the leaf spring 210 can provide a quasi-constant force as the angle of the splay changes over the splay range of motion of the hinge system 200 of either the splay hinge 105 or the tip hinge 107. The hinge system 200 can include an axis of rotation, about which the cam 220 rotates. The hinge system 200 can further include a translation mechanism enabling the projection 222 of the cam 220 to slide along the leaf spring 210. Adjusting the position of the projection 222 can alter a pre-load of the force F1 by changing an initial moment arm of the leaf spring 210.

Any of the features, components, and/or parts, including the arrangements and configurations thereof shown in FIGS. 7A-7C can be included, cither alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 7A-7C.

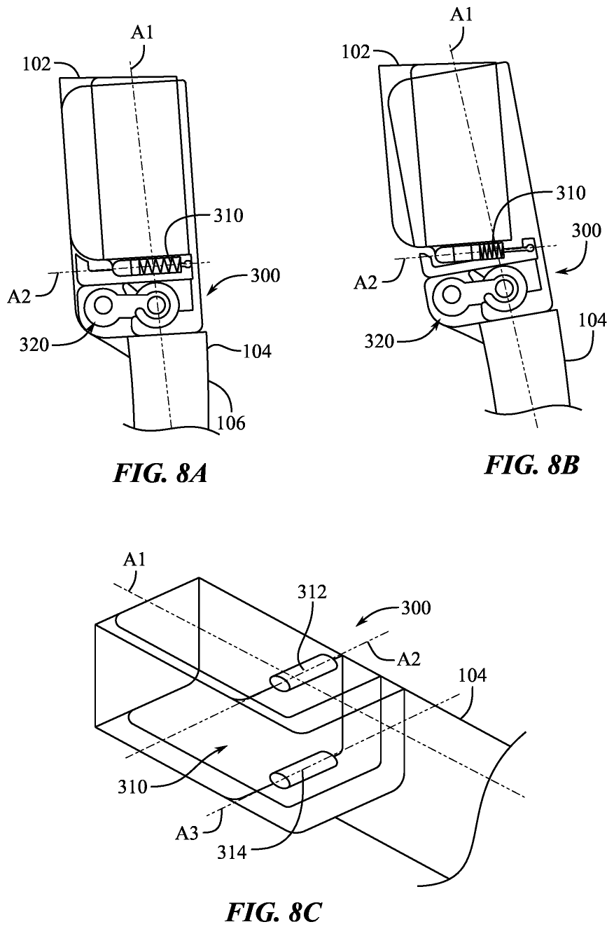

FIGS. 8A-8C illustrate an example of a hinge system 300 for the splay hinge 105. While the hinge system 300 is illustrated and explained with regard to the splay hinge 105, the hinge system 300 can also be used in the tip hinge 107. The hinge system 300 couples the viewing frame 102 to the securement arm 104. The proximal portion 104 of the securement arm 104 defines a first longitudinal axis A1. In at least one example, the hinge system 300 includes a compression spring 310. The compression spring 310 defines a second longitudinal axis A2. In the default position of FIG. 8A, the second longitudinal axis A2 of the compression spring 310 is disposed perpendicular to the first longitudinal axis A1. Another hinge 320 can include a torsion spring for folding the securement arms 104 against the viewing frame 102 (not shown in FIGS. 8A-8C) during storage of the head-mountable electronic device 100. FIG. 8A illustrates the hinge system 300 in a default position and the securement arm 104 in a default position relative to the viewing frame 102. The compression spring 310 can include a low spring constant and a high preload. As the hinge system 300 begins to splay outward past the default position and the compression spring 310 is compressed, as illustrated in FIG. 8B, the force provided by the hinge system 300 remains relatively constant over the splay range of motion of the hinge system 300 from 0° to 20° because of the low spring constant, within 5 percent, and the high preload of the compression spring 310. In other words, the compression spring 310 provides a quasi-constant force as the angle of the splay changes over the splay range of motion of the hinge system 300.

FIG. 8C illustrates an example of the hinge system 300 with two compression springs 310. A first compression spring 312 defines the second longitudinal axis A2 and the second compression spring 314 defines a third longitudinal axis A3. The two compression springs 312, 314 are both disposed perpendicular to the longitudinal axis A1. In the illustrated example, the first compression spring 312 is disposed above the second compression spring 314 relative to a vertical orientation of the securement arm 104.

Any of the features, components, and/or parts, including the arrangements and configurations thereof shown in FIGS. 8A-8C can be included, cither alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 8A-8C.

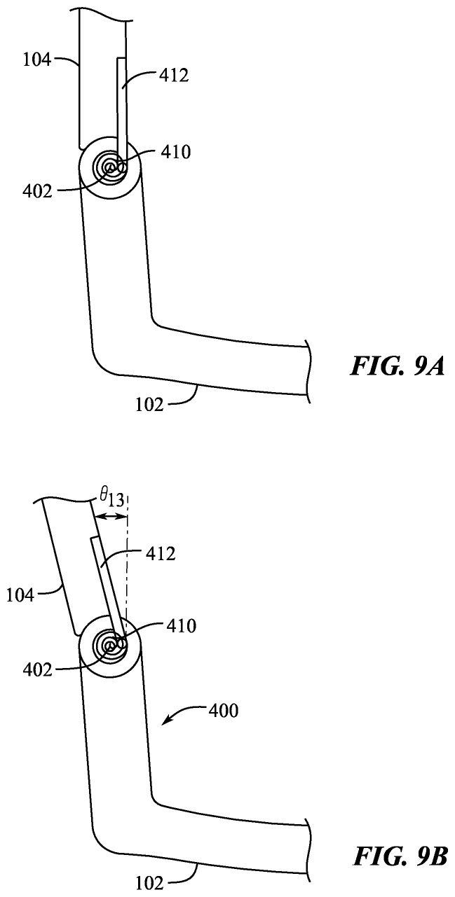

FIGS. 9A and 9B illustrate a hinge system 400 for a splay hinge 105. While the hinge system 400 is illustrated and explained with regard to the splay hinge 105, the hinge system 400 can also be used in the tip hinge 107. The hinge system 400 includes a spiral spring 410. FIG. 9A illustrates the hinge system 400 in a default position and the securement arm 104 in a default position relative to the viewing frame 102. The spiral spring 410 is disposed around an axis of rotation 402 and a distal end 412 of the spiral spring 410 is disposed and fixed within the securement arm 104. FIG. 9B illustrates the securement arm 104 splayed outward past the default position at a thirteenth angle θ13. As discussed above, the splay range of motion of the hinge system 400 can be between 0° and 20°. As the securement arm 104 splays outward, the spiral spring 410 uncoils and provides a quasi-constant force over the splay range of motion due to the spiral spring 410. In other words, the spiral spring 410 provides a quasi-constant force as the angle of the splay changes over the splay range of motion of the hinge system 400. In some examples, the hinge system 400 can include two spiral springs that uncoil as the securement arm 106 splays.

Any of the features, components, and/or parts, including the arrangements and configurations thereof shown in FIGS. 9A-9B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 9A-9B.

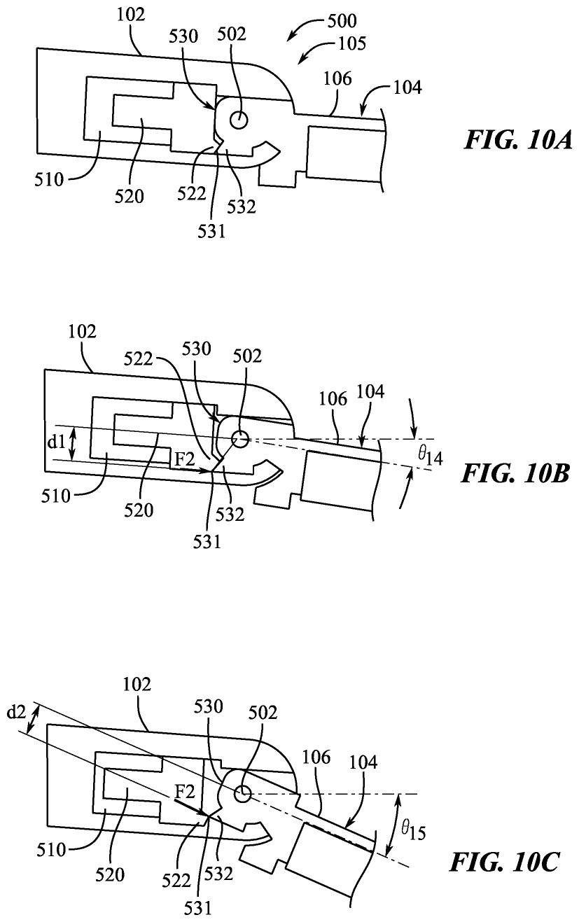

FIGS. 10A-10C illustrate an example of a hinge system 500 for the splay hinge 105. While the hinge system 500 is illustrated and explained with regard to the splay hinge 105, the hinge system 500 can also be used in the tip hinge 107. FIG. 10A illustrates the hinge system 500 in a default position. The hinge system 500 can include a compression spring 510, a plunger 520, and an engagement surface 530 defined or disposed at a proximal end of the proximal portion 106 of the securement arm 104. The compression spring 510 and the plunger 520 can be disposed within the viewing frame 102. The engagement surface 530 can be configured to engage the plunger 520 at a contact point 531. In at least one example, the engagement surface 530 is configured to rotate about an axis of rotation 502. In the illustrated example, the engagement surface 530 includes a projection 532 configured to engage with a projection 522 of the plunger 520. The hinge system 500 is configured to provide a quasi-constant force as the proximal portion 106 of the securement arm 104 rotates about the axis of rotation 502. In one example, as the splay of the securement arm 104 increases past the default position, the distance d1, d2 between where the engagement surface 530 of the securement arm 104 engages the plunger 520, e.g. the contact point 531, and the axis of rotation 502 of the hinge system 500 decreases.

FIG. 10B illustrates the proximal portion 106 of the securement arm 104 splaying outward past the default position of the securement arm 104 to the viewing frame 102 (not shown) at a fourteenth angle θ14. As the securement arm 104 splays outward, the hinge system 500 provides a force F2. The force F2 is determined by the force of the compression spring 510 due to the compression by the plunger 520 and the distance dl of the line of action of the force F3 from the axis of rotation 502.

FIG. 10C illustrates the proximal portion 106 of the securement arm 104 splaying outward past the default position of the securement arm 104 to the viewing frame 102 at a fifteenth angle θ15. The fifteenth angle θ15 is greater than the fourteenth angle θ14 of FIG. 10B. The distance d2 of the line of action of the force F3 changes as the securement arm 104 splays further out and the distance d2 decreases relative to the distance in FIG. 10B. In at least one example, as the force F2 increases due to the compression of the compression spring 510, the line of action of the force F2 relative to the axis of rotation 502 decreases. The force F2 is a quasi-constant force, meaning the force F2 in FIG. 10B and the force F2 in FIG. 10C are similar, for example are within 5 percent of each other. Thus, the force F2 of the hinge system 500 remains quasi-constant, and can remain nearly the same, as the securement arm 104 splays outward over the predetermined splay range of motion of the splay of the splay hinge 105.

Any of the features, components, and/or parts, including the arrangements and configurations thereof shown in FIGS. 10A-10C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 10A-10C.

In some examples, the various hinge systems can include a spring with preload that is adjustable. The preload of the spring can be adjusted by the user, the manufacturer, or the vendor. The adjustability of the preload the spring enables the hinge systems to achieve a flatter and/or more controllable force profile as they are used in the various hinge systems. In other words, the adjustability of the preload enables the hinge system to achieve a quasi-constant force over a splay range of motion of the hinge system. In some examples, the user can adjust the preload of the spring of the hinge system depending on the activity. For example, the preload of the spring can be decreased for sedentary activity, whereas the preload can be increased for dynamic activities.

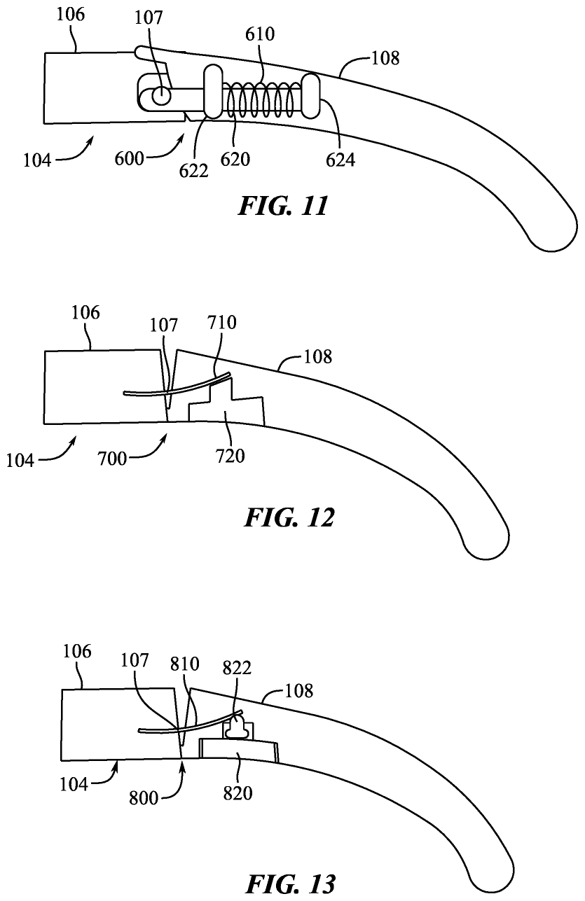

FIG. 11 illustrates an example of a hinge system 600 for the tip hinge 107 between the proximal portion 106 and the distal portion 108 of the securement arm 104 with a spring having an adjustable preload. While the hinge system 600 is illustrated and explained with regard to the tip hinge 107, the hinge system 600 can also be used for the splay hinge 105. The hinge system 700 can be configured to bias inward the distal portion inward when the distal portion 108 of the securement arm 104 is splayed outward from the default position. For example, when the head-mountable electronic device 100 is worn by a user, the distal portion 108 of the securement arm 104 conforms to the shape of the head 12 of the user 10 and the hinge system 600 applies a quasi-constant force to secure the head-mountable electronic device 100 to the head 12 of the user 10. The hinge system 600 can further include a plunger 620 with a first end 622 and a second end 624 opposite the first end 622. The compression spring 610 can be disposed around the plunger 620 between the first end 622 and the second end 624. The position of the second end 624 can be fixed, whereas the position of the first end 622 can be adjusted. A user can adjust the position of the first end 622 relative to the second end 624 to compress or decompress the compression spring 610 to change a preload of the compression spring 610 and affect the quasi-constant force output by the hinge system 600.

Any of the features, components, and/or parts, including the arrangements and configurations thereof shown in FIG. 11 can be included, cither alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 11.

FIG. 12 illustrates an example of a hinge system 700 for the tip hinge 107 between the proximal portion 106 and the distal portion 108 of the securement arm 104 with a spring having an adjustable preload. While the hinge system 700 is illustrated and explained with regard to the tip hinge 107, the hinge system 700 can also be used in the splay hinge 105. At least one example of the hinge system 700 can includes a leaf spring 710 configured to bias the securement arm 104 to the default position when the distal portion 108 of the securement arm 104 is splayed outward from the default position. For example, when the head-mountable electronic device 100 is worn by a user, the distal portion 108 of the securement arm 104 conforms to the shape of the head 12 of the user 10 and the hinge system 700 applies a quasi-constant force to secure the head-mountable electronic device 100 to the head 12 of the user 10.

In one example, the hinge system 700 includes an interchangeable component 720 having a projection 722. In one example, the interchangeable component 720 can be a material block. The shape and material of the material block can vary and be configured to engage the leaf spring 710 within the securement arm as shown. The interchangeable component 720 can be configured to cover the leaf spring 710. The projection 722 of the interchangeable component 720 can engage the leaf spring 710 and adjust the preload of the leaf spring 710. The hinge system 700 can include a plurality of different interchangeable components 720, each interchangeable component 720 having a projection with a different length. The different lengths of the interchangeable components 720 can apply different preloads to the leaf spring 710 based on the associated length. Accordingly, a manufacturer, retailer, or user can adjust the preload of the leaf spring 710 by interchanging one of the interchangeable components 720 with a different projection length, thereby adjusting the preload of the leaf spring 710 to affect the quasi-constant force output by the hinge system 700.

Any of the features, components, and/or parts, including the arrangements and configurations thereof shown in FIG. 12 can be included, cither alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 12.

FIG. 13 illustrates an example of a hinge system 800 for the tip hinge 107 between the proximal portion 106 and the distal portion 108 of the securement arm 104. In one example, the hinge system 800 can include a spring having an adjustable preload. While the hinge system 800 is illustrated and explained with regard to the tip hinge 107, the hinge system 800 can also be used in the splay hinge 105. In one example, the hinge system 800 includes a leaf spring 810 biasing the distal portion 108 inward when the securement arm 104 is splayed outward from the default position. For example, when the head-mountable electronic device 100 is worn by a user, the distal portion 108 of the securement arm 104 conforms to the shape of the head 12 of the user 10 and the hinge system 800 applies a quasi-constant force to secure the head-mountable electronic device 100 to the head 12 of the user 10. The hinge system 800 can further include a screw 822 engaging the leaf spring 810 and a cover 820 adjacent to the leaf spring 810 and configured to cover and hide the leaf spring 810 and the screw 822. The cover 820 can be removably attachable such that the cover 820 can be removed. The screwed can be rotated. For example, the screw 822 can be rotated to tightened or loosened to increase or decrease the preload of the leaf spring 810 and the cover an be replaced. For example, the screw 822 can be rotated in a first direction to increase the preload of the leaf spring 810 and the screw 822 can be rotated in a second direction opposite the first direction to decrease the preload of the leaf spring 810. After the screw is adjusted, the cover 820 can be secured to visually cover and obstruct a view of the screw 822. Accordingly, a manufacturer, retailer, or user can adjust the preload of the leaf spring 810 and thereby affect the quasi-constant force output by the hinge system 800

Any of the features, components, and/or parts, including the arrangements and configurations thereof shown in FIG. 13 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 13.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A head-mountable electronic device, comprising:
a viewing frame;
a window secured to the viewing frame;
a waveguide configured to direct light displayed at the window; and
a pair of securement arms extending distally from the viewing frame, each securement arm of the pair of securement arms comprising:
a hinge; and
a proximal portion connected to the viewing frame at the hinge, the proximal portion having a splay range of motion up to 20 degrees outward from a default position and relative to the viewing frame; and
wherein the hinge is configured to apply a force of the proximal portion against a head between 50 Nmm and 90 Nmm within the splay range of motion.

2. The head-mountable electronic device of claim 1, wherein:
each securement arm of the pair of securement arms further comprises:
a tip hinge; and
a distal portion connected to the proximal portion at the tip hinge;
the splay range of motion is a first splay range of motion; and
the distal portion includes a second splay range of motion up to 25 degrees outward beyond a default position of the distal portion relative to the proximal portion;
the force is a first force; and
the tip hinge is configured to apply a second force of the distal portion against the head between 20 Nmm and 45 Nmm within the second splay range of motion.

3. The head-mountable electronic device of claim 2, wherein:
the first splay range of motion is between 4 degrees and 15 degrees;
the proximal portion is configured to apply the first force within the first splay range;
the second splay range of motion is between 5 degrees and 20 degrees; and
the distal portion is configured to apply the second force within the second splay range.

4. The head-mountable electronic device of claim 3, wherein:
the first force varies less than 5 percent within the first splay range of motion; and
the second force varies less than 5 percent within the second splay range.

5. The head-mountable electronic device of claim 1, wherein the hinge comprises:
a cam; and
a spring engaging the cam.

6. The head-mountable electronic device of claim 5, wherein:
the cam comprises a projection engaging the spring; and
the cam is configured to translate relative to the projection.

7. The head-mountable electronic device of claim 1, wherein:
the proximal portion defines a first longitudinal axis; and
the hinge comprises a compression spring defining a second longitudinal axis disposed perpendicular to the first longitudinal axis.

8. The head-mountable electronic device of claim 7, wherein:
the compression spring is a first compression spring;
the hinge comprises a second compression spring defining a third longitudinal axis;
the third longitudinal axis is disposed perpendicular to the first longitudinal axis; and
the first compression spring is disposed adjacent the second compression spring.

9. The head-mountable electronic device of claim 1, wherein the hinge comprises a spiral spring.

10. The head-mountable electronic device of claim 9, wherein:
the spiral spring is a first spiral spring; and
the hinge comprises a second spiral spring.

11. The head-mountable electronic device of claim 1, wherein the hinge comprises a spring having an adjustable preload.

12. The head-mountable electronic device of claim 1, wherein:
the hinge comprises:
a compression spring; and
a plunger;
the proximal portion comprises a proximal end of the securement arm, the proximal end including an engagement surface engaging the plunger; and
when the splay of the securement arm increases past the default position, a distance between where the engagement surface of the securement arm engages the plunger and an axis of rotation of the splay hinge decreases.

13. A wearable device, comprising:
a frame; and
a securement arm extending from the frame, the securement arm comprising:
a distal portion;
a proximal portion coupled to the frame, the proximal portion disposed between the distal portion and the frame; and
a tip hinge rotatably connecting the proximal portion to the distal portion;
wherein:
the distal portion is rotatable outward from a default position of the distal portion relative to the proximal portion;
the tip hinge comprises a spring configured to bias the distal portion toward the default position when the distal portion is rotated outward from the default position; and
the spring includes an adjustable preload.

14. The wearable device of claim 13, wherein:
the tip hinge comprises a screw disposed within the securement arm, the screw engaging the spring; and
a rotation of the screw adjusts the preload of the spring.

15. The wearable device of claim 14, wherein:
the securement arm further comprises a removably attachable cover adjacent to the spring; and
removing the cover provides user access to the screw.

16. The wearable device of claim 13, wherein:
the securement arm comprises an interchangeable block having a projection configured to engage the spring, the projection having a length; and
the preload of the spring is based on the length.

17. The wearable device of claim 13, wherein the spring is a compression spring and the preload of the spring is adjustable by compressing or decompressing the compression spring.

18. A wearable device, comprising:
a frame;
a securement arm extending distally from the frame, the securement arm comprising:
a proximal portion defining an engagement surface; and
a hinge coupling the proximal portion to the frame, the hinge comprising:
a compression spring; and
a plunger;
wherein:
the hinge defines a splay angle range of the proximal portion relative to the frame of 20 degrees beyond a default angle;
the engagement surface is configured to engage the plunger at a contact point to compress the compression spring during a rotation of the securement arm relative to the frame; and
when an angle of the securement arm relative to the frame increases beyond the default angle, a distance between the contact point and an axis of rotation of the hinge decreases.

19. The wearable device of claim 18, wherein:
the plunger comprises a first projection;
the engagement surface defines a second projection; and
the first projection is configured to engage the second projection.

20. The wearable device of claim 18, the securement arm further comprising:
a distal portion; and
a tip hinge coupling the proximal portion to the distal portion;
wherein:
the splay angle range is a first splay angle range;
the default angle is a first default angle;
the tip hinge defines a second splay angle range of the distal portion relative to the proximal portion of 25 degrees beyond a second default angle;
the tip hinge comprises a spring biasing the distal portion toward the second default angle; and
a preload of the spring of the tip hinge is adjustable.
